(19) United States
(12) Patent Application Publication
(10) Pub. No.: US 2012/0311269 A1
(43) Pub. Date: Dec. 6, 2012

(54) NON-UNIFORM MEMORY-AWARE CACHE MANAGEMENT

(76) Inventors: Gabriel H. Loh, Bellevue, WA (US); Jaewoong Chung, Bellevue, WA (US); Nuwan Jayasena, Sunnyvale, CA (US); Steve Reinhardt, Vancouver, WA (US); James O'Connor, Austin, TX (US); Kevin McGrath, Los Gatos, CA (US)

(21) Appl. No.: 13/153,102

(22) Filed: Jun. 3, 2011

(51) Int. Cl. G06F 12/08

(52) U.S. Cl. 711/133; 711/E12.017

(57) ABSTRACT

An apparatus is disclosed for caching memory data in a computer system with multiple system memories. The apparatus comprises a data cache for caching memory data. The apparatus is configured to determine a retention priority for a cache block stored in the data cache. The retention priority is based on a performance characteristic of a system memory from which the cache block is cached.

### BACKGROUND

Computer systems may include different instances and/or kinds of main memory storage with different performance characteristics. For example, a given microprocessor may be able to access memory that is integrated directly on top of the processor (e.g., 3D stacked memory integration), interposer-based integrated memory, multi-chip module (MCM) memory, conventional main memory on a motherboard, and/or other types of memory. In different systems, such system memories may be connected directly to a processing chip, associated with other chips in a multi-socket system, and/or coupled to the processor in other configurations.

Because different memories may be implemented with different technologies and/or in different places in the system, a given processor may experience different performance characteristics (e.g., latency, bandwidth, power consumption, etc.) when accessing different memories. For example, a processor may be able to access a portion of memory that is integrated onto that processor using stacked dynamic random access memory (DRAM) technology with less latency and/or more bandwidth than it may a different portion of memory that is located off-chip (e.g., on the motherboard). As used herein, a performance characteristic refers to any observable performance measure of executing a memory access operation.

To facilitate access to memory data, processors often include one or more small, fast memory caches to cache memory data that is likely to be needed again soon. When the processor needs to access memory, it first checks the data cache for the data and accesses main memory only if the required data is not in the cache. In this manner, the processor may often avoid the performance penalty of accessing main memory.

Because caches are relatively small with respect to main memory capacity, each cache implements various cache management policies usable to decide when to cache data, what data to cache, what data to retain in cache, and what data to evict. For example, when a new data block is brought into the cache, the cache uses an eviction policy to decide which data block in the cache should be evicted to make space for the new block. The evicted block may be referred to as the victim block.

An eviction operation, whereby a resident victim block is evicted to make space for a new cache block, may introduce performance penalties. For example, if the victim block is dirty (i.e., has been modified and not yet written back to main memory), then the cache must perform a writeback operation, whereby the modified data is written back to memory, which introduces a performance penalty associated with accessing main memory. In another example, if an evicted victim block is subsequently referenced again, then the system may need to reload the block from main memory in a reload operation, which also introduces a performance penalty associated with accessing main memory. Memory access operations that result from evicting a cache block (e.g., writeback, reload operations, etc.) may be referred to herein generally as eviction penalties.

Traditional cache management policies attempt to minimize the number of eviction penalties by maximizing cache hit rates. For example, an LRU policy attempts to maximize hit rates by attempting to evict the cache block that is least likely to be reused, which the policy assumes is the least recently accessed cache block. By attempting to maximize hit rates, traditional cache management policies (e.g., LRU, PLRU, NRU, Clock, etc.) attempt to minimize the number of eviction penalties.

### SUMMARY OF EMBODIMENTS

An apparatus is disclosed for caching memory data in a computer system with multiple system memories. The apparatus comprises a data cache for caching memory data. The apparatus is configured to determine a retention priority for a cache block stored in the data cache. The retention priority is based on a performance characteristic of a system memory from which the cache block is cached.

In some embodiments, the performance characteristic may depend on a type of memory used to implement the system memory or on a location within the apparatus where the system memory is situated with respect to the caching logic. The characteristic may include latency, bandwidth, power consumption, and/or other measures of access to the memory.

In some embodiments, the caching logic may be configured to determine the retention priority using an insertion policy and/or a promotion policy, each of which may be based on the performance characteristic. The caching logic may be configured to prioritize retention of blocks that correspond to a relatively high-latency system memory over those that correspond to a relatively low-latency system memory.

### BRIEF DESCRIPTION OF THE DRAWINGS

FIG. 1a is a block diagram illustrating a computer system that implements main memory using different memory technologies with different performance characteristics, according to some embodiments.

FIG. 1b is a block diagram illustrating some components of an example NUMA system, according to some embodiments.

FIG. 2 is a flow diagram illustrating a method for implementing a cache management policy that accounts for different eviction penalties, according to some embodiments.

FIG. 3a is a flow diagram illustrating a method of implementing an eviction policy that considers respective memory performance, according to some embodiments.

FIG. 3b is a block diagram illustrating an eviction of a block with lowest priority, according to some embodiments.

FIG. 3c is a block diagram illustrating an eviction of a block with second lowest priority, according to some embodiments.

FIG. 4a is a flow diagram illustrating a method of implementing an insertion policy that considers respective memory performance, according to some embodiments.

FIG. 4b is a block diagram illustrating an insertion of a block with a heightened initial retention priority, according to some embodiments.

FIG. 4c is a block diagram illustrating an insertion of a block with a lowered retention priority, according to some embodiments.

FIG. 5a is a flow diagram illustrating a method of implementing a promotion policy that considers respective performance of different memories, according to some embodiments.

FIG. 5b is a block diagram illustrating a promotion of an accessed block with a high promotion degree, according to some embodiments.

FIG. 5c is a block diagram illustrating a promotion of a block corresponding to a faster memory, according to some embodiments.

FIG. 6 is a block diagram illustrating a computer system configured to employ memory-sensitive cache management policies as described herein, according to some embodiments.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, in a processor having two or more data caches, the terms “first” and “second” caches can be used to refer to any two of the two or more data caches elements. In other words, the “first” and “second” caches are not limited to caches in particular levels of the cache hierarchy.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The effectiveness of a data cache is in large part dependent on the cache's management policies. A cache management policy may refer to any logic and/or mechanisms by which the cache logic determines which cache blocks to insert and/or evict and when. For example, many modern caches utilize an LRU cache management policy or some approximation thereof

Traditional cache management policies attempt to minimize the number of eviction penalties by maximizing cache hit rates. Such policies, however, ignore the potentially different magnitudes of those penalties. For example, in systems with more than one system memory, the latency of memory access may vary depending on the particular system memory that is accessed. The term system memory is used herein to refer to one or more memory hardware components that implement at least some portion of a system's overall main memory physical address space. Performing a writeback operation to a 3D stacked memory, for instance, may be significantly faster than performing the same writeback to off-chip memory. Likewise, in a non-uniform memory access (NUMA) machine, performing a writeback to a processor's local memory may be significantly faster than performing a writeback to remote memory attached to a different processor. Therefore, a policy that attempts only to minimize the number of eviction penalties without regard to their respective magnitudes may be sub-optimal.

Different system memories may vary along performance characteristics other than or in addition to latency, such as bandwidth, power consumption, and/or others. Accordingly, the term “performance characteristic,” as used herein, refers to any metric of performing an access to a given system memory, such as a latency, bandwidth, power consumption, reliability, write-endurance, or any other characteristic of the memory.

According to various embodiments, caching logic may be configured to implement cache management policies that consider the relative performance penalties of evicting different cache blocks. Such a performance penalty may take the form of any performance characteristic of the memory from which a given block is cached. As used herein, a cache block is cached from a given system memory if the cache block stores memory data that corresponds to a block of the given system memory. That is, data in a memory block was read into the cache block and any modifications to the data in the cache block will eventually be written back to the memory block (unless the modification is nullified, such as by a concurrency protocol, etc.).

In some embodiments, the management policy may consider the latency, bandwidth, and/or other performance characteristics of accessing different system memories that store each cache block. For example, the caching logic may prioritize retention of memory blocks that correspond to slower memories. Thus, a cache block corresponding to a faster memory (e.g., stacked DRAM) may be victimized before another cache block corresponding to a slower memory (e.g., off-chip DRAM), even though the cache block corresponding to the faster memory was accessed more recently. A cache management policy that considers both the probability of reusing a given cache block and the performance penalty of evicting that cache block may increase cache performance over a policy that attempts only to maximize hit rates.

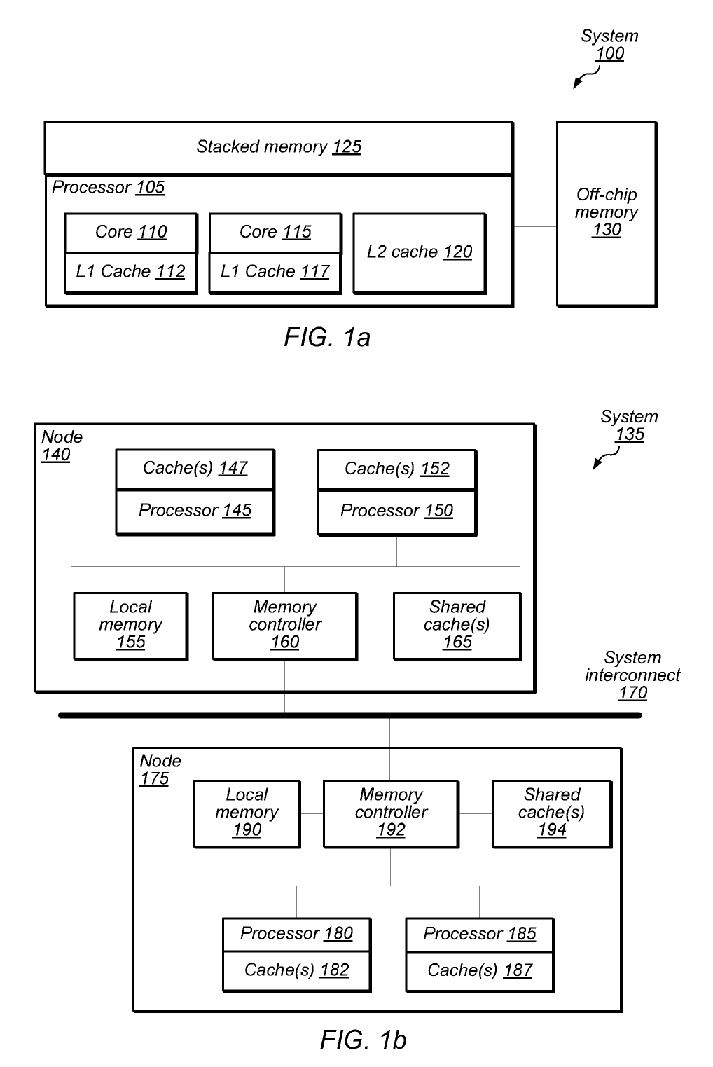

FIG. 1a is a block diagram illustrating a computer system that implements main memory using different memory technologies with different performance characteristics, according to some embodiments. The illustrated system is intended to provide one example of a system that implements caching and different main memories. However, in various embodiments, the caching techniques described herein may be applied to multi-memory systems with different and/or additional memories and cache structures.

According to FIG. 1a, system 100 includes a multi-core processor 105 that has access to two kinds of main system memory: off-chip memory 130 and stacked memory 125. Off-chip memory 130 may be separate from processor 105. For example, off-chip memory 130 may be implemented as one or more DRAM chips on a motherboard that also hosts processor 105. Thus, processor 105 may access data in memory 130 via a motherboard-provided interconnect. In contrast to off-chip memory 130, stacked memory 125 may be stacked directly on processor 125. For example, stacked memory 125 may be constructed using multiple layers of active silicon bonded with dense, low-latency, high-bandwidth vertical interconnects. Compared to off-chip DRAM, such as 130, stacked memory 125 may significantly reduce wire delays between the processor and memory, thereby offering increased data bandwidth, decreased latency, and/or lower energy requirements. In some embodiments, stacked memory 125 may also include different memory technologies, such as DRAM, SRAM, high-speed CMOS, high-density DRAM, eDRAM, and/or others. Therefore, stacked memory 125 and off-chip memory 130 may offer processor 105 different performance characteristics from one another.

System 100 also includes multiple data caches, which may include caching logic configured to implement cache management policies that consider the relative performance characteristics of memories 125 and 130, as described herein. In the illustrated embodiment, processor 105 includes two cores 110 and 115. Each core has access to a respective L1 data cache (i.e., core 110 to L1 cache 112 and core 115 to L1 cache 117) and the two cores share access to a shared L2 data cache 120. The caching logic of caches 112, 117, and/or 120 may be configured to implement cache management policies that consider the relative latency and/or bandwidth of accessing stacked memory 125 versus off-chip memory 130.

In some embodiments, different system memories may offer different processors varied performance characteristics, even when the memories are implemented with the same technologies. For example, in NUMA systems, a processor may access node-local memory more quickly than the processor can access remote memory implemented on a different node. Thus, the performance characteristics that a processor experiences when accessing a given portion of memory may be dependent on the processor's position in the system relative to the memory.

FIG. 1b is a block diagram illustrating some components of an example NUMA system, according to some embodiments. The illustrated system is intended to provide one example of components in a system that implements caching and main memories that offer different access latencies and/or bandwidths. However, in various embodiments, the caching techniques described herein may be applied to multi-memory systems with different and/or additional memories and cache structures.

System 135 is an example NUMA system that includes two symmetric processing nodes, 140 and 175, connected by a system interconnect 170. Each node includes two processors, a local memory, and various data caches.

System 135 includes multiple processors, each of which may be implemented on a separate chip connected to a respective socket. For example, processors 145 and 150 of node 140 may be implemented as separate chips and connected to one another via an intra-node interconnect, as shown. Any of the processors may include multiple cores on a single chip (e.g., dual-core, quad-core, etc.).

System 135 may also include multiple memories (e.g., 155, 190), each of which may be accessed more quickly by processors on the same node than by processors on a different node. In one embodiment, each memory is usable to store shared memory data accessible by any of the processors. However, a processor on a given node may be able to access local memory on the same node with lower latency and/or higher bandwidth than it could access a remote memory on another node. For example, processor 145 on node 140 may be able to access local memory 155 using only an intra-node interconnect and memory controller 160. However, to access memory 190 on node 175, processor 145 may use the intra-node interconnect of node 140, memory controller 160, system interconnect 170, and memory controller 192. Therefore, access to remote memory may be slower than access to local memory on the same node.

System 135 may also include multiple data caches (e.g., 147, 152, 165, 182, 187, and 194), which may implement cache management policies that account for the different performance characteristics of accessing different memories in the NUMA system. For example, when determining retention priorities and/or making eviction decisions for cache 165, caching logic may consider that access to local memory 155 is faster than access to memory 190 on node 175. Accordingly, in some embodiments, the caching logic may prioritize retention of blocks that correspond to remote memory 190 and/or deprioritize retention of blocks that correspond to a local memory, such as 155.

A cache management policy that considers relative eviction penalties of accessing different memory blocks, as described herein, may be decomposed into three distinct policies: an eviction policy, an insertion policy, and a promotion policy. An eviction policy corresponds to the portion of the management policy that is used to select a victim for immediate eviction, a decision that may depend on respective retention priorities of the cache blocks. The retention priorities are maintained by the insertion and promotion policies. An insertion policy corresponds to the portion of the management policy that is used to determine an initial retention priority for a new cache block when the block is first brought into cache. A promotion policy corresponds to the portion of the management policy that is used to determine a new retention priority for a resident cache block in response to detecting that a processor has accessed the cache block. Thus, the insertion and promotion policies together maintain respective retention priorities for cache blocks and the eviction policy uses those priorities to determine which block to evict. The eviction policy does not itself calculate or otherwise update the retention priorities.

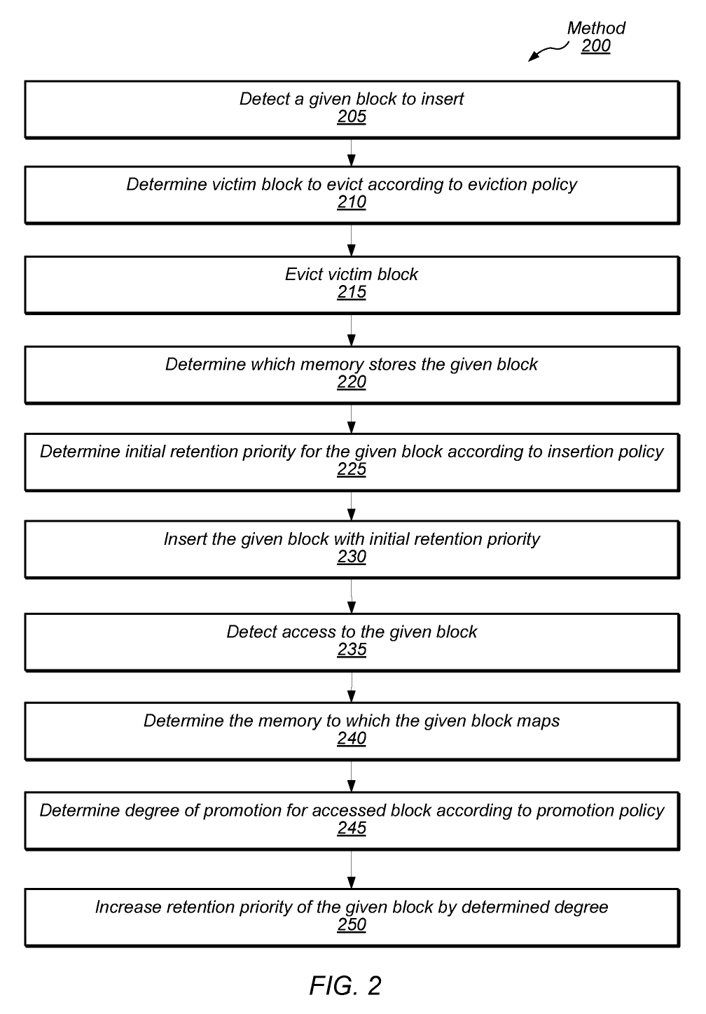

FIG. 2 is a flow diagram illustrating a method for implementing a cache management policy that accounts for different eviction penalties, according to some embodiments. The method of FIG. 2 may be executed by caching logic, which may be implemented as part of a processor, part of the cache itself, and/or separately.

Method 200 begins when the caching logic detects a given block to insert, as in 205. For example, in response to the processor accessing data in main memory, the caching logic may determine whether the data is already in cache. If the data is not in cache, the caching logic may identify a block of main memory that contains the accessed data and bring that block into the cache as a new cache block. In such a situation, the identified block of main memory may be the block detected in 205.

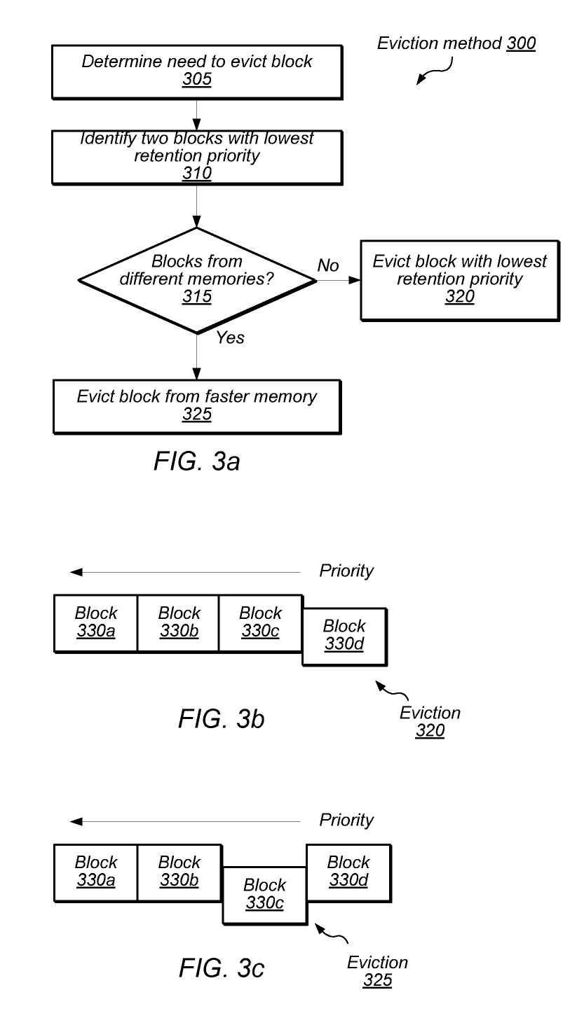

In 210, the caching logic uses an eviction policy to determine a victim block to evict from the cache. In some embodiments, the eviction policy may simply always select the block with the lowest retention priority for eviction. In other embodiments, however, the eviction policy may consider the performance characteristics of different memories when determining which block to evict. For example, in some embodiments, the eviction policy may determine which block to evict by applying a heuristic that accounts for both retention priority and the performance characteristics of the respective memories that store each of the possible victim blocks. In system 100 for instance, one heuristic may consider the N lowest-priority blocks, and evict the lowest-priority one that maps to stacked (fast) memory 125; if the N blocks all map to the off-chip memory 130, then the logic may evict the block with lowest priority. Such an embodiment is described in more detail with respect to FIGS. 3a-3c.

In 215, the caching logic evicts the victim block determined in 210. In some instances, evicting the victim block in 215 may comprise performing a writeback operation, setting one or more flags, clearing data from the cache block, and/or sending various cache coherence messages to other cores and/or processors.

In 220, the caching logic determines which memory stores the given block that is being inserted. For example, using system 100, the caching logic may determine in 220 whether the block being inserted corresponds to stacked memory 125 or off-chip memory 130. In some embodiments, the caching logic may determine which memory stores the given block by checking the memory address range into which the block falls.

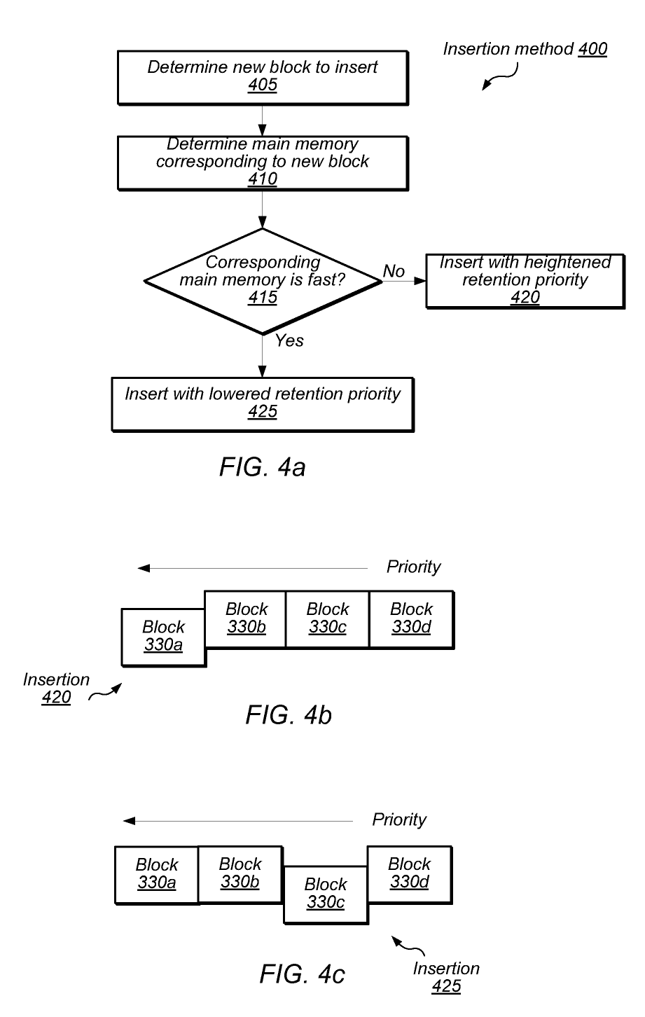

In 225, the caching logic uses the insertion policy to determine an initial retention priority for the given block. In some embodiments, the logic may consider performance characteristics of the memory to which the block maps, such as by assigning a higher initial retention priority to blocks that map to slower memories than to those that map to faster memories. For example, in system 100, a cache block that maps to stacked memory 125 may receive a lower initial retention priority than does a block that maps to off-chip memory 130. An example of such an insertion policy is described in more detail below with respect to FIGS. 4a-4c.

In 230, the caching logic inserts the given cache block into the cache with the determined initial retention priority. In some embodiments, inserting the block into cache may comprise copying the corresponding memory data from the main memory into the cache block, setting one or more flags associated with the cache block, and/or sending various cache coherence messages to other cores and/or processors.

Because retention priorities are relative among the blocks of a cache, inserting the block into the cache with an initial retention priority, as in 230, may or may not comprise modifying the respective retention priorities of one or more others of the blocks. Various different mechanisms for assigning retention priorities and/or maintaining relative retention ordering will become apparent to those skilled in the art given the benefit of this disclosure. For example, the blocks of the cache may be maintained as an ordered list, each block may be assigned a respective retention priority that is updated when a new block is inserted, and/or each newly inserted block is assigned a retention priority relative to the other blocks such that the retention priority of the resident block need not be updated upon the insert operation. It is intended that this disclosure apply to all such techniques.

After inserting a given block, the caching logic may detect an access to the given block, as in 235. For example, the logic may detect the access in 235 in response to a processing core executing an instruction that reads or modifies the data in the cache block. An access to memory data that is resident in cache may be referred to as a cache hit.

In response to the cache hit, the caching logic, in one embodiment, determines the memory to which the given block maps, as in 240. In 245, the caching logic uses the promotion policy to determine a degree by which to promote the retention priority of the accessed block, and in 250, the logic increases the retention priority of the accessed block by the determined degree. In some embodiments, the promotion degree may depend, at least in part, on various performance characteristics of the memory determined in 240. For example, the promotion degree for an accessed block that maps to a faster memory may be less than a promotion degree for a cache block that maps to a slower memory. Thus, the promotion policy may prioritize retention of cache blocks that map to slower memories over those that map to faster memories. The term “promotion degree” is used generally to refer to an amount, a quantity, a relative position, and/or any other measure by which a retention priority may be increased. The specific implementation of the promotion degree may depend on the mechanisms by which retention priorities are maintained.

FIG. 3a is a flow diagram illustrating a method of implementing an eviction policy that considers respective memory performance, according to some embodiments. Method 300 may be performed by caching logic, such as that configured to perform method 200. In some embodiments, method 300 may correspond to a specific implementation of steps 205-215 of method 200.

Method 300 begins when the caching logic determines that a block must be evicted from cache, as in 305. Step 305 may correspond to step 205 and may be performed in response to a cache miss, as described above.

In 310, the caching logic determines the two blocks with lowest retention priority. These blocks will be considered for eviction. However, in other embodiments, the caching logic may consider a greater number of blocks for eviction. In other embodiments, the caching logic may consider additional blocks beyond the two with lowest eviction priorities (e.g., three blocks with lowest retention priorities).

In 315, the caching logic determines whether the two lowest-priority blocks map to different memories. If the two lowest-priority blocks map to the same memory, as indicated by the negative exit from 315, the caching logic evicts the block with the lowest retention priority, as in 320. If the two blocks map to different memories, however, as indicated by the affirmative exit from 315, the logic evicts the block that maps to the faster of the two memories, as in 325. In some embodiments, rather than always evicting the cache block from the faster memory (as in 325), the caching logic may be configured to evict the cache block that maps to the faster memory with some predefined probability p and to evict the cache block that maps to the slower memory with a probability 1-p. Thus, an unused cache block that maps to a slow memory is unlikely to stay in the lowest-priority position indefinitely.

FIG. 3b is a block diagram illustrating an eviction of a block with lowest priority, such as in step 320 of method 300. FIG. 3b depicts four cache blocks (330a-330d), organized in decreasing retention priority from left to right. For example, cache blocks 330a-330d may be blocks in a cache set of a set associative cache. As shown in FIG. 3b, eviction step 320 removes the cache block with lowest retention priority (i.e., block 330d).

FIG. 3c is a block diagram illustrating an eviction of a block with second lowest priority, such as is possible in step 325 of method 300. FIG. 3c depicts the same four cache blocks as FIG. 3b (330a-330d) ordered in decreasing retention priority order from left to right. However, in step 325, the cache logic evicts whichever of the two lowest-priority blocks maps to the faster memory, even if the other block was more recently accessed. For example, if block 330c maps to a fast memory (e.g., stacked memory 125 of FIG. 1) and block 330d maps to a slower memory (e.g., off-chip memory 130 of FIG. 1), the caching logic evicts block 330c in step 325, even if block 330d was more recently accessed.

FIG. 4a is a flow diagram illustrating a method of implementing an insertion policy that considers respective memory performance, according to some embodiments. Method 400 may be performed by caching logic, such as that configured to perform method 200. In some embodiments, method 400 may correspond to a specific implementation of steps 220-230 of method 200.

Method 400 begins when the caching logic determines a new block to insert, as in 405. As described above, the caching logic may determine the new block in response to detecting a cache miss. For example, in response to determining that a processor has attempted to access memory data that is not resident in the cache, the caching logic may determine a block of memory that contains the accessed memory data and insert the block into the cache.

In 410, the caching logic determines the memory to which the new block corresponds. If the corresponding memory is the faster of the two memories, as indicated by the affirmative exit from 415, the caching logic inserts the block into the cache with a lower retention priority, as in 425. On the other hand, if the corresponding memory is the slower of the two memories, as indicated by the negative exit from 415, the caching logic inserts the block into the cache at a heightened retention priority. Thus, in some embodiments, the caching logic may consider both recency of access and the performance of the corresponding memory when determining an initial retention priority for a new block.

Method 400 is an example of a method usable in a system with two memories, such as system 100. For example, cache blocks that map to stacked memory 125 may be inserted with a lowered retention priority (as in 425) and blocks that map to off-chip memory 130 may be inserted with a heightened retention priority (as in 420). But method 400 may be adapted to operate with an arbitrary number of memories without loss of generality. For example, in a system with an arbitrary number of memories, decision 415 may be augmented to determine an initial retention priority that is dependent on the performance characteristics of the corresponding memory determined in 410.

FIG. 4b is a block diagram illustrating an insertion of a block with a heightened initial retention priority, as in 420. FIG. 4b depicts four cache blocks (330a-330d), organized in decreasing retention priority from left to right. In the embodiment of FIG. 4b, insertion step 420 includes assigning the accessed block 330a the highest retention priority of the four blocks. In other embodiments, however, the accessed block may be inserted with an initial priority lower than the highest.

FIG. 4c is a block diagram illustrating an insertion of a block with a lowered retention priority, as in 425. Rather than being inserted at the highest retention priority, as in 420 and FIG. 4b, block 330c is inserted with a lower initial priority.

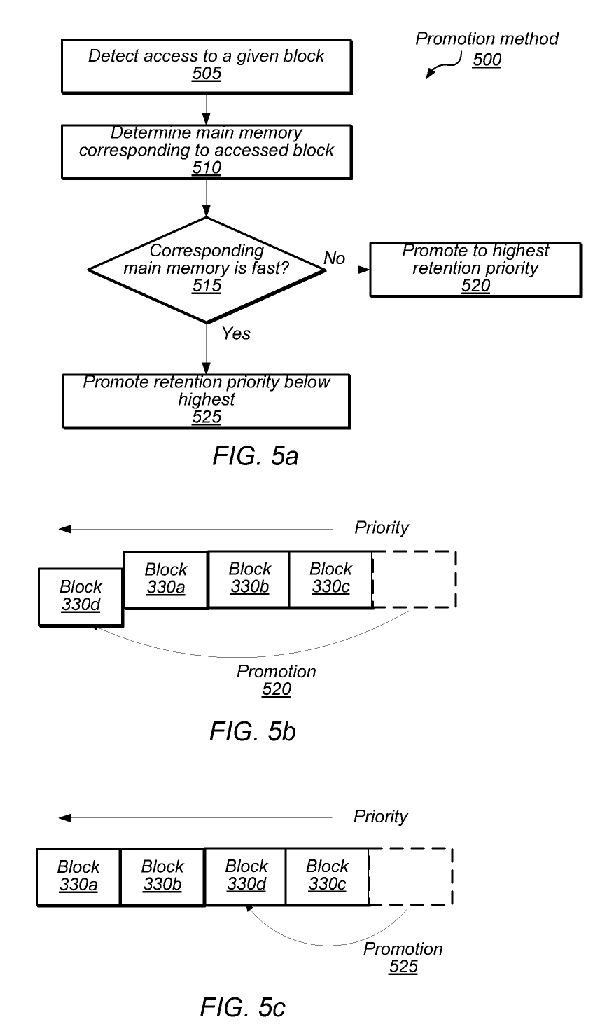

FIG. 5a is a flow diagram illustrating a method of implementing a promotion policy that considers respective performance of different memories, according to some embodiments. Method 500 may be performed by caching logic, such as that configured to perform method 200. In some embodiments, method 500 may correspond to a specific implementation of steps 235-250 of method 200.

Method 500 begins when the caching logic detects an access to a given cache block, as in 505. As described above, the caching logic may detect the access in 505 in response to a cache hit. For example, in response to determining that a processor has attempted to access memory data that is resident in the cache, the caching logic may determine a cache block that contains the accessed memory data increase the retention priority of that block.

In 510, the caching logic determines the main memory to which the accessed block corresponds. If the corresponding main memory is the faster of the two memories, as indicated by the affirmative exit from 515, the caching logic promotes the retention priority of the accessed cache block to a level below the highest retention priority, as in 525. If the corresponding memory is the slower of the two memories, as indicated by the negative exit from 515, the caching logic promotes the retention priority of the accessed block to the highest retention priority level, as in 520.

Like method 400, method 500 is one example of a method usable in a system with two different memories, such as system 100. For example, cache blocks that map to stacked memory 125 may be promoted to a limited extent (as in 525) and blocks that map to off-chip memory 130 may be promoted to the top retention priority (as in 420). However, method 500 may be adapted to operate with an arbitrary number of memories without loss of generality. For example, in a system with an arbitrary number of memories, decision 515 may be augmented to determine a degree of promotion that is dependent on the performance characteristics of the corresponding memory determined in 510. Moreover, the respective promotion amounts may differ across different embodiments. For example, promotion degrees may be chosen as a function of one or more performance characteristics of each type of memory.

In various embodiments, the promotion policy may consider various factors in addition to performance characteristics. For example, the degree of promotion in steps 520 and/or 525 may further depend on how frequently the block has been accessed while in cache, on a random or pseudorandom number, and/or on other factors. Thus, the overall retention priority of a block may be dependent on the performance characteristics of the underlying system memory and on access recency, access frequency, and/or other factors.

FIG. 5b is a block diagram illustrating a promotion of an accessed block with a high promotion degree, as in 420. FIG. 5b depicts four cache blocks (330a-330d), organized in decreasing retention priority from left to right. In the figure, block 330d was accessed. In response to determining that the main memory to which memory block 330d corresponds is a slow memory (e.g., affirmative exit from 515), the retention priority of block 330d is promoted to the highest priority, as in 520. In other embodiments, the accessed block may be promoted to a lesser degree, but to a greater degree than it would have been had the block mapped to the faster memory.

FIG. 5c is a block diagram illustrating a promotion of a block corresponding to a faster memory, as in 525. Rather than being promoted to the highest retention priority, as in 520 and FIG. 5b, when block 330d is accessed, it is promoted less aggressively. In FIG. 5c, the promotion is only by one position relative to the other blocks. In various embodiments, the degree of promotion may vary. For example, the degree of promotion may be a function of the relative performance of the corresponding memory.

In some embodiments, the caching logic may impose a limit on the retention priority of a block that maps to a fast memory implementation. For example, in an 8-way set associative cache, low-latency (fast memory) blocks may be allowed to be promoted at most to the third-highest retention priority, thereby reserving the two highest retention-priority slots for high-latency (slow memory) blocks.

In various embodiments, the eviction, insertion, and/or promotion policies may be implemented without the need to add significant storage capabilities to existing cache designs. Besides logic for determining which memory stores data in a given cache block (e.g., by checking the address range of the data), the cache management logic may require only limited combinatorial logic to implement the policies described herein.

Although many of the embodiments described herein were configured to choose between two different classes of memory (i.e., slow and fast), the techniques may be extended to systems with more than two classes of memory (e.g., local 3D-stacked, local off-chip, remote off-chip, disaggregated memory on a different printed circuit board, etc.). For each class of memory, different eviction, insertion, and/or promotion decisions can be made to favor or discourage the retention of data blocks from different ones of the memories to different extents.

In another variant, the caching logic may also consider whether a candidate victim block is dirty. Since evicting a dirty block may require a writeback operation, evicting blocks that are not dirty may be faster. In such embodiments, even if the writeback operation does not block a pending insertion (e.g., if the writeback operation uses a buffer outside the main cache array to store the dirty data during writeback), evicting blocks that are not dirty instead of dirty blocks may minimize external buffer usage and increase opportunities for further writes to the cache block to be coalesced with the cache itself.

The techniques described herein may be generally applicable to many different cache designs, such that various types of caches that implement different cache management policies (e.g., LRU, PLRU, RRIP, NRU, Clock, etc.) may be easily modified to implement the techniques. For example, in a cache that implements an LRU policy, retention priorities may correspond to positions in the cache's recency stack. Therefore, according to some embodiments, a block may be inserted into, promoted within, and/or evicted from the recency stack in a manner dependent on the speed of the memory to which the block maps. In another example, a cache that implements a re-reference interval prediction (RRIP) management policy stores a retention priority for each cache block in a respective M-bit counter and updates the counter on insertion, promotion, and eviction operations. Though traditional RRIP caches update the counters without regard to eviction penalties (i.e., latency of writeback and/or reload operations), in various embodiments, such caches may be modified to initialize and update the counter in a manner dependent on the memory to which a given block maps. In such embodiments, the RRIP context may provide different counter initialization values on insertion, different counter increment amounts on promotion, and/or different counter decrement amounts during the eviction process, all dependent on whether the block came from a faster or slower memory.

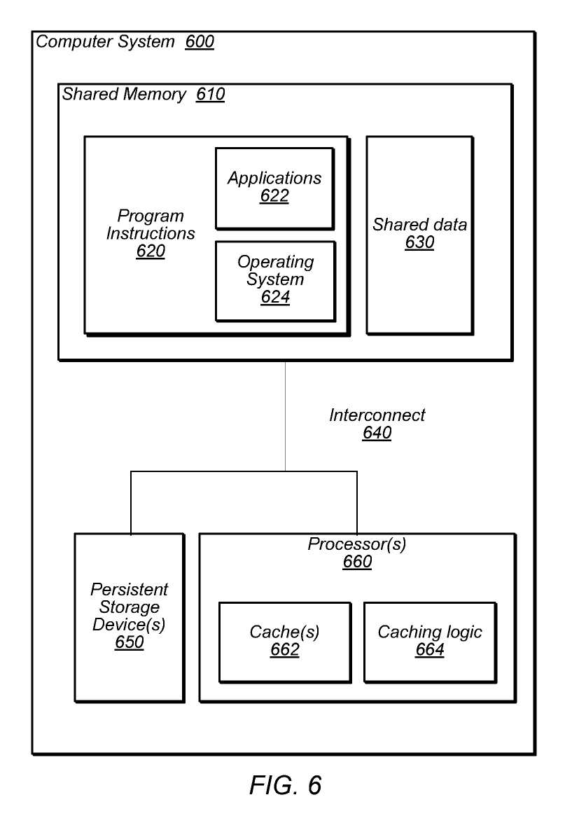

FIG. 6 is a block diagram illustrating a computer system configured to employ memory-sensitive cache management policies as described herein, according to some embodiments. The computer system 600 may correspond to any of various types of devices, including, but not limited to, a personal computer system, desktop computer, laptop or notebook computer, mainframe computer system, handheld computer, workstation, network computer, a consumer device, application server, storage device, a peripheral device such as a switch, modem, router, etc, or in general any type of computing device.

Computer system 600 may include one or more processors 660, any of which may include multiple physical and/or logical cores. Any of processors 660 may correspond to processor 105 of FIG. 1 a and may include data caches, such as caches 662. Caches 662 may include multiple caches at different levels of a cache hierarchy, as described herein. For example, caches 662 may correspond to L1 caches 112 and 117, L2 cache 120, and/or to other caches. Caches 662 may also include caching logic, such as 664, that is configured to implement memory performance-sensitive management policies, as described herein. Computer system 600 may also include one or more persistent storage devices 650 (e.g. optical storage, magnetic storage, hard drive, tape drive, solid state memory, etc), which may persistently store data.

According to the illustrated embodiment, computer system 600 includes one or more shared memories 610 (e.g., one or more of cache, SRAM, DRAM, stacked memory, RDRAM, EDO RAM, DDR, SDRAM, Rambus RAM, EEPROM, etc.), which may be shared between multiple processing cores, such as on one or more of processors 660. In some embodiments, different ones of processors 660 may be configured to access shared memory 610 with different latencies. In some embodiments, shared memory 610 may include multiple different types of memories, various ones of which may be capable of accessing memory at different speeds.

The one or more processors 660, the storage device(s) 650, and shared memory 610 may be coupled via interconnect 640. In various embodiments, the system may include fewer or additional components not illustrated in FIG. 6 (e.g., video cards, audio cards, additional network interfaces, peripheral devices, a network interface such as an ATM interface, an Ethernet interface, a Frame Relay interface, monitors, keyboards, speakers, etc.). Additionally, different components illustrated in FIG. 6 may be combined or separated further into additional components.

In some embodiments, shared memory 610 may store program instructions 620, which may be encoded in platform native binary, any interpreted language such as Java™ byte-code, or in any other language such as C/C++, Java™, etc. or in any combination thereof. Program instructions 620 may include program instructions to implement one or more applications 622, any of which may be multi-threaded. In some embodiments, program instructions 620 may also include instructions executable to implement an operating system 624, which may provide software support to applications 622, such as scheduling, software signal handling, etc.

According to the illustrated embodiment, shared memory 610 includes shared data 630, which may be accessed by ones of processors 660 and/or various processing cores thereof at different latencies and/or bandwidths. Ones of processors 660 may cache various components of shared data 630 in local caches (e.g., 662) as described herein, and coordinate the data in these caches by exchanging messages according to a cache coherence protocol. In some embodiments, multiple ones of processors 660 and/or multiple processing cores of processors 660 may share access to caches 662 and/or off-chip caches.

Program instructions 620, such as those used to implement applications 622 and/or operating system 624, may be stored on a computer-readable storage medium. A computer-readable storage medium may include any mechanism for storing information in a form (e.g., software, processing application) readable by a machine (e.g., a computer). The computer-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions.

A computer-readable storage medium as described above may be used in some embodiments to store instructions read by a program and used, directly or indirectly, to fabricate hardware comprising one or more of processors 660. For example, the instructions may describe one or more data structures describing a behavioral-level or register-transfer level (RTL) description of the hardware functionality in a high level design language (HDL) such as Verilog or VHDL. The description may be read by a synthesis tool, which may synthesize the description to produce a netlist. The netlist may comprise a set of gates (e.g., defined in a synthesis library), which represent the functionality of processor 500. The netlist may then be placed and routed to produce a data set describing geometric shapes to be applied to masks. The masks may then be used in various semiconductor fabrication steps to produce a semiconductor circuit or circuits corresponding to processors 60 and/or 660. Alternatively, the database may be the netlist (with or without the synthesis library) or the data set, as desired.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
a data cache;
caching logic configured to determine a retention priority for a cache block stored in the data cache, wherein the caching logic is configured to determine the retention priority for the cache block based on a performance characteristic of a system memory from which the cache block is cached.

2. The apparatus of claim 1, wherein the performance characteristic is based on a type of memory used to implement the system memory.

3. The apparatus of claim 1, wherein the performance characteristic is based on a location within the apparatus where the system memory is situated with respect to the caching logic.

4. The apparatus of claim 1, wherein the performance characteristic is at least one of latency, bandwidth, power consumption, reliability, or write-endurance.

5. The apparatus of claim 1, wherein the caching logic is configured to prioritize retention of cache blocks that correspond to a relatively high-latency system memory over cache blocks that correspond to a relatively low-latency system memory.

6. The apparatus of claim 1, wherein the caching logic is configured to determine the retention priority using at least an insertion policy, wherein the insertion policy is usable to determine an initial retention priority for the cache block in response to storing new memory data in the cache block, wherein the initial retention priority is based on the performance characteristic of the system memory from which the cache block is cached.

7. The apparatus of claim 6, wherein the insertion policy is usable to determine another initial retention priority for another block in response to storing memory data from another system memory in the other block, wherein a difference between the initial retention priority and the another initial retention priority is a function of a difference between the performance characteristic of the system memory and the performance characteristic of the another system memory.

8. The apparatus of claim 1, wherein the caching logic is configured to determine the retention priority using at least a promotion policy, wherein the promotion policy is usable to determine a degree by which to increase the retention priority in response to a processor accessing the cache block, wherein the degree of promotion is based on the performance characteristic of the system memory from which the cache block is cached.

9. The apparatus of claim 8, wherein the promotion policy is usable to determine another degree of promotion for another cache block in response to a processor accessing the another cache block, wherein a difference between the degree of promotion and the another degree of promotion is a function of a difference between the performance characteristic of the system memory from which the cache block is cached and the performance characteristic of another system memory from which the another cache block is cached.

10. The apparatus of claim 1, wherein the caching logic is further configured to implement an eviction policy for determining a victim block for eviction from the cache, wherein the victim cache is selected from among a group of blocks with lowest retention-priority according to a probability that is based on the performance characteristic of a respective memory from which the victim block is cached.

11. The apparatus of claim 10, wherein the probability is 1 when: no block in the group has a lower retention priority than the victim and can be read with lower latency than the victim.

12. The apparatus of claim 1, wherein the retention priority is further based on how recently the cache block was accessed.

13. The apparatus of claim 1, wherein the caching logic maintains the retention priority for the block in a counter associated with the block.

14. A computer-implemented method comprising:
a computer determining a retention priority for a cache block of a data cache, wherein the retention priority is based on a performance characteristic of a system memory from which the cache block is cached;
the computer selecting the cache block for eviction from the cache, wherein the selecting is based on the retention priority of the block with respect to that of other blocks in the data cache; and
in response to selecting the cache block for eviction, evicting the cache block from the cache.

15. The method of claim 14, wherein the performance characteristic is based on a type of memory used to implement the system memory.

16. The method of claim 14, wherein determining the retention priority comprises: determining an initial retention priority for the cache block in response to storing new memory data in the cache block, wherein the initial retention priority is based on the performance characteristic of the system memory from which the cache block is cached.

17. The method of claim 14, wherein determining the retention priority comprises: increasing the retention priority by a degree of promotion in response to a processor accessing the cache block, wherein the degree of promotion is based on the performance characteristic of the system memory from which the cache block is cached.

18. The method of claim 14, further comprising: determining a victim block for eviction from the cache, wherein the victim cache is selected from among a group of blocks with lowest retention-priority according to a probability that is based on the performance characteristic of a system memory from which the victim block is cached.

19. A computer readable storage medium comprising a data structure which is operated upon by a program executable on a computer system, the program operating on the data structure to perform a portion of a process to fabricate an integrated circuit including circuitry described by the data structure, the circuitry described in the data structure including:
a data cache;
caching logic configured to determine a retention priority for a cache block stored in the data cache, wherein the retention priority is based on a performance characteristic of a system memory from which the cache block is cached.

20. The computer readable storage medium of 19, wherein the storage medium stores HDL, Verilog, or GDSII data.
